(19) United States
(12) Patent Application Publication
(10) Pub. No.: US 2018/0307789 A1
(43) Pub. Date: Oct. 25, 2018

(54) STATISTICAL ANALYSIS METHOD FOR TECHNOLOGICAL PARAMETERS OF GaN DEVICES BASED ON LARGE-SIGNAL EQUIVALENT CIRCUIT MODEL

(71) Applicant: University of Electronic Science and Technology, Sichuan (CN)

(72) Inventors: Yuehang Xu, Sichuan (CN); Zhang Wen, Sichuan (CN); Ruimin Xu, Sichuan (CN); Bo Yan, Sichuan (CN)

(21) Appl. No.: 15/565,553

(22) PCT Filed: Jul. 12, 2016
(86) PCT No.: PCT/CN2016/089712

§ 371 Date: Oct. 10, 2017

(51) Int. Cl. G06F 17/50

(52) U.S. Cl. CPC G06F 17/5036; G06F 2217/16

(57) ABSTRACT

A statistical analysis method for technological parameters of GaN devices based on equivalent circuit model is provided. The analysis method includes the following steps: establishing a GaN device small-signal equivalent circuit model, and extracting small-signal model parameters; establishing a GaN device large-signal equivalent circuit model, and extracting large-signal model parameters; tuning and optimizing the large-signal model parameters by targeting the measured microwave characteristics of the device; and extracting technological parameters of GaN devices in multiple batches based on the established large-signal model, and statistically analyzing the technological parameters. In the method for statistically analyzing technological parameters of GaN devices, first, a GaN device small-signal equivalent circuit model is established, a GaN device large-signal equivalent circuit model associated with technological parameters is then established, and the statistical distribution of the technological parameters is eventually obtained by modeling of devices in multiple batches.

### CROSS-REFERENCE TO RELATED APPLICATION

This application is a national phase of PCT/CN2016/089712, filed on Jul. 12, 2016. This prior application is incorporated herein by reference in its entirety.

### TECHNICAL FIELD

The present invention relates to the technical field of gallium nitride (GaN) high electron mobility transistors (GaN HEMTs), and in particular, to a statistical analysis method for technological parameters of GaN devices based on large-signal equivalent circuit model.

### BACKGROUND

Due to their high frequency, high power density and other properties, GaN HEMTs play a very important role in microwave/millimeter-wave solid-state power circuits. Since the existing mainstream circuit design approaches are generally based on device models which describe characteristics of a device under small-signal and large-signal operating conditions, in form of equivalent circuits, the device models are the premises of applying devices in circuit design.

However, since there exists unintentional doping and fluctuation in technological parameters during the fabrication of devices, the consistency of device performances will be influenced, and the yield of circuit designs is thus influenced. Therefore, it is necessary to instruct the circuit yield analysis by establishing a statistical model. The conventional statistical methods perform analysis based on small-signal model parameters or part of large-signal model parameters. As a result, is the conventional methods are insufficient in accuracy. Moreover, is the conventional methods are unable to instruct the device yield design and technological parameter optimization by statistically analyzing specific technological parameters with a large-signal statistical model.

### SUMMARY

To overcome the deficiencies described above in the prior art, the present invention provides a statistical analysis method for technological parameters of GaN devices based on a large-signal equivalent circuit model, which can effectively determine statistical characteristics of technological parameters of GaN devices and thus assist in instructing the circuit yield analysis.

To solve the technical problem, the present invention employs the following technical solutions: a statistical analysis method for technological parameters of GaN devices based on a large-signal equivalent circuit model is provided, including the following steps:
step 1: establishing a GaN device small-signal equivalent circuit model, and extracting small-signal model parameters;
step 2: establishing a GaN device large-signal equivalent circuit model associated with technological parameters, and extracting large-signal model parameters, the large-signal model parameters including non-linear current source model parameters and non-linear capacitance model parameters;
step 3: tuning and optimizing the large-signal model parameters by targeting the measured microwave characteristics of the device; and
step 4: extracting technological parameters of GaN devices in multiple batches based on the established large-signal model, and statistically analyzing the technological parameters.

In some embodiments, the small-signal model parameters include parasitic parameters and intrinsic parameters, wherein the parasitic parameters include parasitic capacitance, parasitic resistance and parasitic inductance, and the intrinsic parameters include intrinsic capacitance, intrinsic resistance, current source and output conductance.

In some embodiments, the method for extracting small-signal model parameters includes:
testing scattering parameters of a GaN device in the GaN device small-signal equivalent circuit model under pinch-off condition;
extracting, according to the scattering parameters under pinch-off condition, parasitic parameters in the small-signal equivalent circuit model; and
de-embedding all the parasitic parameters, and then calculating small-signal model intrinsic parameters corresponding to each bias point.

In some embodiments, after extracting small-signal model parameters, the step 1 further includes:
obtaining simulated scattering parameters by simulation, according to the small-signal model parameters;
comparing the simulated scattering parameters with the measured scattering parameters to obtain a fitting scattering parameters curve; and
setting a first set of tuning parameters, and repetitively modifying the first set of tuning parameters, according to the degree of fitting of the fitting scattering parameters curve until the degree of fitting of the fitting scattering parameters curve conforms to a first set threshold.

In some embodiments, the method for extracting large-signal model parameters includes:
testing a GaN device in the GaN device large-signal equivalent circuit model associated with technological parameters, to obtain pulsed I-V test data and static I-V test data;
extracting, according to the pulsed I-V test data, parameters irrelevant to the self-heating effects in an Ids non-linear model; and
combining the pulsed I-V test data and the static I-V test data to extract parameters relevant to the trapping effects and the self-heating effects in the Ids non-linear model.

In some embodiments, after extracting large-signal model parameters, the step 2 further includes:
simulating, according to the parameters irrelevant to the self-heating effects in the Ids non-linear model and the parameters relevant to the trapping effects and the self-heating effects in the Ids non-linear model, to obtain pulsed I-V simulated data and static I-V simulated data, respectively;
comparing the pulsed I-V simulated data and static I-V simulated data with the corresponding pulsed I-V test data and static I-V test data, respectively, to obtain I-V fitting curves;
setting a second set of tuning parameters, and repetitively modifying the second set of tuning parameters, according to the degree of fitting of the I-V fitting curves until the degree of fitting of the I-V fitting curves conforms to a second set threshold;
extracting the intrinsic capacitances of the intrinsic parameters, calculating non-linear capacitance model parameters by fitting values of the intrinsic capacitances at multiple biases;
comparing the calculated non-linear capacitance model parameters with the extracted non-linear capacitance model parameters to obtain a contrast ratio; and
setting a third set of tuning parameters, and repetitively modifying the third set of tuning parameters, according to the contrast ratio to tune the non-linear capacitance model parameters until the contrast ratio conforms to a third set threshold.

In some embodiments, the method for tuning and optimizing the large-signal model parameters includes:
importing the small-signal model parameters and the large-signal model parameters;
setting a fourth set of tuning parameters, and calculating microwave characteristics of the device, wherein the fourth set of tuning parameters includes device structural and technological parameters such as the thickness of a barrier layer, doping concentration, gate length, gate width and Al component, and the microwave characteristics of the large-signal equivalent circuit model include at least one of output power, power-added efficiency and gain;
comparing the calculated microwave characteristics of the device and the measured microwave characteristics to obtain a fitting microwave characteristic curve; and
repetitively modifying the fourth set of tuning parameters, according to the degree of fitting of the fitting microwave characteristic curve until the degree of fitting of the fitting microwave characteristic curve conforms to a fourth set threshold.

In some embodiments, the method for statistically analyzing the technological parameters includes:
importing the pulsed I-V test data and static I-V test data of a device to be analyzed, and the small-signal model parameters;
extracting all technological parameters relevant to physical model parameters in the large-small equivalent circuit model; and
drawing a frequency distribution histogram based on the values of the technological parameters.

In some embodiments, the physical parameters include device structural and technological parameters during the fabrication of GaN devices.

The present invention has the following positive effects:

In the statistical analysis method for technological parameters of GaN devices based on a large-signal equivalent circuit model of the present invention, first, a GaN device small-signal equivalent circuit model is established, a GaN device large-signal equivalent circuit model associated with physical parameters is then established, and statistical analysis is eventually performed on the technological parameters, so that the fluctuation in the technological parameters can be determined accurately and effectively, and the accuracy of device models in the yield analysis is thus improved.

### BRIEF DESCRIPTION OF THE DRAWINGS

Various additional features and advantages of the invention will become more apparent to those of ordinary skill in the art upon review of the following detailed description of one or more illustrative embodiments taken in conjunction with the accompanying drawings. The accompanying drawings, which are incorporated in and constitute a part of this specification, illustrate one or more embodiments of the invention and, together with the general description given above and the detailed description given below, explain the one or more embodiments of the invention:

FIG. 1 is a flowchart of a statistical analysis method for technological parameters of GaN devices based on a large-signal equivalent circuit model, according to an embodiment of the present invention;

FIG. 2 is a schematic diagram of a small-signal equivalent circuit model of a GaN device used in the method shown in FIG. 1;

FIG. 3 is a schematic diagram of a large-signal equivalent circuit model of a GaN device used in the method shown in FIG. 1; and

FIG. 4 is a statistical diagram of thickness parameters of a device barrier layer, extracted by using the large-signal equivalent circuit model of FIG. 3.

### DETAILED DESCRIPTION

The technical solutions in the embodiments of the present invention will be clearly and completely described below with reference to the accompanying drawings in the embodiments of the present invention. Apparently, the embodiments described herein are merely a part but not all the embodiments of the present invention. All other embodiments obtained by those skilled in the art without any creative effort based on the embodiments in the present invention shall fall into the protection scope of the present invention.

An objective of the present invention is to provide a statistical analysis method for technological parameters of GaN devices based on a large-signal equivalent circuit model. First, a GaN device small-signal equivalent circuit model is established; then, a GaN device large-signal equivalent circuit model associated with technological parameters is established; and eventually, statistical characteristics of the technological parameters are obtained, so that the yield analysis of devices and the optimization of technological parameters can be performed effectively.

To make the objectives, features and advantages of the present invention more clear and comprehensible, the present invention will be further described below in detail with reference to the accompanying drawings and the embodiments.

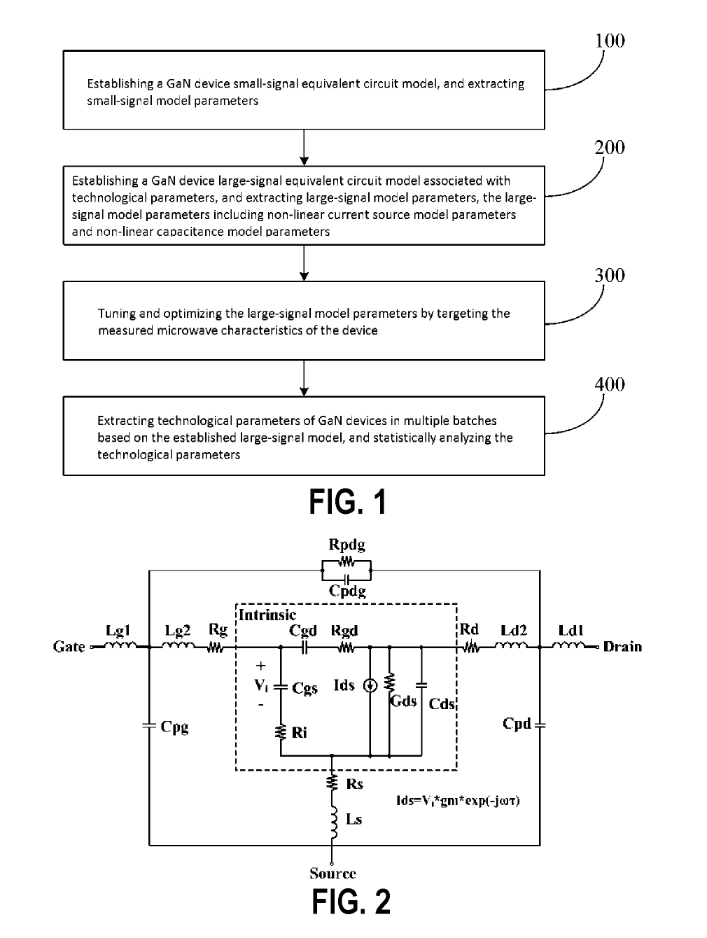

As shown in FIG. 1, the statistical analysis method for technological parameters of GaN devices based on a large-signal equivalent circuit model of the present invention includes the following steps:
step 100: establishing a GaN device small-signal equivalent circuit model, and extracting small-signal model parameters;
step 200: establishing a GaN device large-signal equivalent circuit model associated with technological parameters, and extracting large-signal model parameters, the large-signal model parameters including non-linear current source model parameters and non-linear capacitance model parameters;
step 300: tuning and optimizing the large-signal model parameters by targeting the measured microwave characteristics of the device; and
step 400: extracting technological parameters of GaN devices in multiple batches based on the established large-signal model, and statistically analyzing the technological parameters.

Further, the small-signal model parameters include parasitic parameters and intrinsic parameters, wherein the parasitic parameters include parasitic capacitance, parasitic resistance and parasitic inductance, and the intrinsic parameters include intrinsic capacitance, intrinsic resistance, current source and output conductance.

As shown in FIG. 2, the intrinsic part is shown in a block, and the values of the intrinsic parameters of the small-signal model are relevant to the bias; and the parasitic part is shown outside the block, and the values of the parasitic parameters are irrelevant to the bias. Cpgi, Cpdi and Cgdi denote the interelectrode capacitance and air-bridge capacitance; Cpga, Cpda and Cgda denote the contact capacitances of the probe and pad; Lg, Ld and Ls denote the parasitic inductances; Rg, Rd and Rs denote the parasitic resistances; Cgd, Cgs and Cds are intrinsic capacitances; Ids is a current source; Rgd and Ri are intrinsic resistances; and, Gds denotes the output conductance.

Wherein, the method for extracting small-signal model parameters includes:
testing scattering parameters of a GaN device in the GaN device small-signal equivalent circuit model under pinch-off condition;
extracting, according to the scattering parameters under pinch-off condition, parasitic parameters in the small-signal equivalent circuit model; and
de-embedding all the parasitic parameters, and then calculating small-signal model parameters corresponding to each bias point.

Specifically, in the small-signal equivalent circuit model, the GaN device is kept in a pinch-off state (the pinch-off state is a state in which the source is grounded, the gate-source bias voltage Vgs is less than the pinch-off voltage of the GaN device, and the drain-source bias voltage Vds is equal to 0).

The step of testing scattering parameters of a GaN device in the small-signal equivalent circuit model under pinch-off condition and further extracting, according to the scattering parameters under pinch-off condition, parasitic parameters specifically includes: first, extracting the parasitic capacitances by using low-frequency data under pinch-off condition; then, de-embedding the parasitic capacitances, and then extracting the parasitic inductances and the parasitic resistances; and, de-embedding all the parasitic parameters, and then calculating the intrinsic parameters one by one at each bias point. Each bias point may be in the following state: Vgs=−4V to 0 V, with an interval of 0.5V; and, Vds=0V to 35 V, with an interval of 5 V.

Preferably, after extracting small-signal model parameters, the step 100 further includes:
obtaining simulated scattering parameters by simulation, according to the small-signal model parameters;
comparing the simulated scattering parameters with the measured scattering parameters to obtain a fitting scattering parameters curve; and
setting a first set of tuning parameters, and repetitively modifying the first set of tuning parameters according to the degree of fitting of the fitting scattering parameters curve until the degree of fitting of the fitting scattering parameters curve conforms to a first set threshold.

In the step 200, the method for extracting large-signal model parameters includes:
testing a GaN device in the GaN device large-signal equivalent circuit model associated with technological parameters, to obtain pulsed I-V test data and static I-V test data;
extracting, according to the pulsed I-V test data, parameters irrelevant to the self-heating effects in an Ids non-linear model;
combining the pulsed I-V test data and the static I-V test data to extract parameters relevant to the trapping effects and the self-heating effects in the Ids non-linear model;
simulating, according to the parameters irrelevant to the self-heating effects in the Ids non-linear model and the parameters relevant to the trapping effects and the self-heating effects in the Ids non-linear model, to obtain pulsed I-V simulated data and static I-V simulated data, respectively;
comparing the pulsed I-V simulated data and static I-V simulated data with the corresponding pulsed I-V test data and static I-V test data, respectively, to obtain I-V fitting curves;
repetitively modifying a second set of tuning parameters according to the degree of fitting of the I-V fitting curves until the degree of fitting of the I-V fitting curves conforms to a second set threshold;
extracting the intrinsic capacitances of the intrinsic parameters, calculating non-linear capacitance model parameters by fitting values of the intrinsic capacitances at multiple biases;
comparing the calculated non-linear capacitance model parameters with the extracted non-linear capacitance model parameters to obtain a contrast ratio; and
setting a third set of tuning parameters, and repetitively modifying the third set of tuning parameters, according to the contrast ratio to tune the non-linear capacitance model parameters until the contrast ratio conforms to a third set threshold.

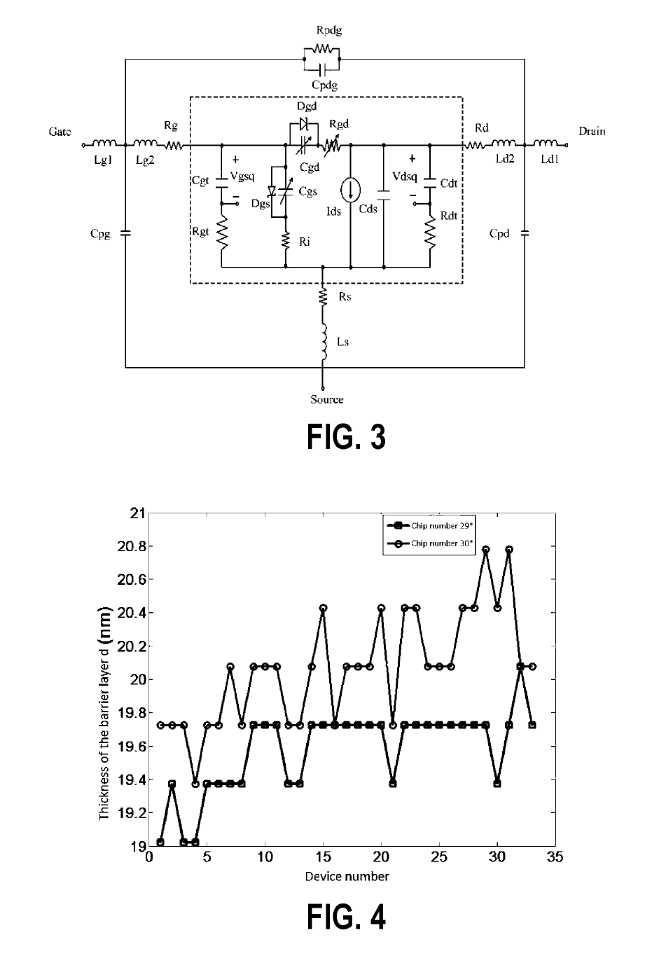

FIG. 3 is a schematic diagram of a typical GaN device large-signal equivalent circuit model. To represent the self-heating effects and the trapping effects of the GaN device, parameters for representing the self-heating effects and the trapping effects of the device are added to the Ids model. Since I-V curves of the device in the specified self-heating effects and trapping effects can be obtained by pulsed I-V tests, both the pulsed I-V test data and the static I-V test data are needed to be used during the extraction of the Ids model parameters.

Specifically, a GaN device in the GaN device large-signal equivalent circuit model associated with technological parameters is tested to obtain pulsed I-V test data and static I-V test data.

After the pulsed I-V test data and static I-V test data are imported, “START CALCULATION” is clicked, and all parameters of the Ids non-linear model are obtained by fitting I-V curves. Wherein, the pulsed I-V test data is used for extracting parameters irrelevant to the self-heating effects in the Ids non-linear model; and, after the parameters irrelevant to the self-heating effects in the Ids non-linear model are obtained, the pulsed I-V test data and the static I-V test data are combined to extract parameters relevant to the trapping effects and the self-heating effects in the Ids non-linear model.

In this embodiment, the non-linear capacitance model parameters include Cgs and Cgd non-linear model parameters. Specifically, a list of values of Cgs and Cgd at multiple biases obtained in the step 100 is imported, and then “START CALCULATION” is clicked to fit the values of Cgs and Cgd at multiple biases, to obtain Cgs and Cgd non-linear capacitance model parameters by calculation. Wherein, the used parameter extraction algorithm is as follows: extracting, based on the commonly used Angelov capacitance model and by theoretical derivation, the model parameters in an analysis manner.

If the contrast ratio is unsatisfactory (does not conform to a third set threshold), a third set of tuning parameters are set; then, the third set of tuning parameters are modified, and “TUNE” is clicked; and, the Cgs and Cgd non-linear capacitance model parameters are recalculated, according to the modified third set of tuning parameters, and the fitting result is updated. The tuning process is performed repetitively. After the satisfactory values of the parameters are obtained, “SAVE” is clicked, and the software saves the latest model parameters into a user-specified path.

In the step 300, the method for tuning and optimizing the large-signal model parameters includes:
importing the intrinsic parameters and the model parameters;
setting a fourth set of tuning parameters, and calculating microwave characteristics of a device, wherein the fourth set of tuning parameters include device structural and technological parameters such as the thickness of a barrier layer, doping concentration, gate length, gate width and Al component, and the microwave characteristics of the large-signal equivalent circuit model include at least one of output power, power-added efficiency and gain;
comparing the calculated microwave characteristics of the device and the measured microwave characteristics to obtain a fitting microwave characteristic curve; and
repetitively modifying the fourth set of tuning parameters according to the degree of fitting of the fitting microwave characteristic curve until the degree of fitting of the fitting microwave characteristic curve conforms to a fourth set threshold.

Specifically, all the parameters (i.e., the small-signal model parameters and the large-signal model parameters) obtained in the steps 100 and 200 are imported; then, the device structural and technological parameters such as the thickness of the barrier layer, doping concentration, gate length, gate width and Al component are set; “START CALCULATION” is clicked; and microwave characteristics (including output power, power-added efficiency and gain) of the large-signal model are obtained by calculation with an existing algorithm, and all the model parameters are displayed.

The microwave characteristics of the GaN device are imported, “IMPORT THE MEASURED DATA” is then clicked, and the calculated microwave characteristics of the large-signal equivalent circuit model and the measured microwave characteristics are drawn in a same coordinate system for comparison. If the fitting result of the simulated result and the measured data is unsatisfactory, the fourth set of tuning parameters are modified, and “TUNE” is clicked. The microwave characteristics of the large-signal equivalent circuit model are recalculated according to the modified fourth set of tuning parameters, and the result of simulation in the simulation-measurement comparison chart is updated. The tuning process is repeated. After the satisfactory parameter values are obtained, the latest model parameters are saved into a user-specified path.

In addition, after the step 100 is performed on each of the devices in multiple batches, all parameters of each device in the small-signal equivalent circuit model are obtained. All the parameters of each device in the small-signal equivalent circuit are saved in a user-specified path.

When importing data, all parameters of all devices to be statistically analyzed in each batch in the small-signal equivalent circuit are imported. Parameters to be statistically analyzed (this software may realize the statistical analysis of Rg, Rd, Rs, Cgs, Cgd, Cds and Gm) and the device structural and technological parameters (the thickness of the barrier layer, doping concentration, gate length, gate width, Al component and the like) are selected. By traversing the parameters one by one, a frequency distribution histogram and a value distribution scatter diagram of the analyzed parameters are obtained. At the end of circulation, a frequency distribution histogram of the analyzed parameters of all devices in each batch at this bias voltage and a value distribution scatter diagram of the analyzed parameters of difference devices in a same batch are drawn.

In addition, after the steps 200 and 300 are performed on each of the devices in multiple batches, all parameters of each device in the large-signal equivalent circuit are obtained. All the large-signal model parameters of each device are saved in a user-specified path.

When importing data, the large-signal model parameters of all devices to be statistically analyzed in each batch are imported. A device to be statistically analyzed is selected, principal component analysis and factor analysis are performed on the model parameters of the selected device to establish a multiple regression model, and a Monte-Carlo simulation is performed to establish a large-signal statistical model. At the end of calculation, the large-signal characteristics simulated by the statistical model are compared with the measured large-signal characteristics of the device.

In the step 400, the method for statistically analyzing the technological parameters includes:
importing the pulsed I-V test data and static I-V test data of a device to be analyzed, and the small-signal model parameters;
extracting all technological parameters relevant to physical model parameters in the large-small equivalent circuit model; and
drawing a frequency distribution histogram based on the values of the technological parameters.

Wherein, the physical parameters include fabrication parameters and physical parameters of materials during the fabrication of the GaN device.

In the present invention, for the intrinsic part of the equivalent circuit, a large-signal surface potential equivalent circuit model is used, a large-signal model associated with the technological parameters is established, and the specific technological parameters may be directly analyzed by the large-signal performance of the device, so that the technological process can be effectively instructed. The implementation way is similar to the equivalent circuit model in the step 200 except that the model parameters are device structural and technological parameters during the fabrication of the device rather than empirical circuit elements.

Specifically, after a device is selected, the I-V test data of the device to be analyzed, the values of Cgs and Cgd at multiple biases and the large-signal characteristic test data are imported, to extract all parameters associated with the physical parameters in the large-signal equivalent circuit. At the end of calculation, a simulation-measurement comparison diagram of the device is drawn, and all model parameters are exhibited. After the parameters of all devices have been extracted, devices needed to be statistically analyzed are selected, the technological parameters are statistically analyzed, and a frequency distribution histogram based on the values of the technological parameters is drawn.

The statistical analysis method for technological parameters of GaN devices based on large-signal equivalent circuit model of the present invention has the following beneficial effects:

First, in the present invention, an automatic parameter extraction interface for a small-signal model and a large-signal model is developed, and a large-signal model tuning and optimization technology is proposed. The complete small-signal and large-signal models can be obtained by running a self-developed software, so that the modeling workload is reduced greatly and the modeling efficiency is improved significantly.

Second, in the present invention, the statistical analysis of all small-signal parameters of the small-signal model is realized, and the fluctuation in technological parameters of devices in different batches and of different devices in a same batch may be simply and intuitively reflected.

Third, in the method for statistically analyzing technological parameters based on an equivalent circuit model of the present invention, by analyzing related technological parameters, the yield analysis of devices and the monitoring and optimization of technological parameters may be realized.

In addition, the statistical analysis method for technological parameters of GaN devices based on large-signal equivalent circuit model of the present invention is applicable for devices made of other semiconductor materials (e.g., silicon, gallium arsenide, indium phosphide, diamond and the like), and has a broad scope of application.

What is claimed is:

1. A statistical analysis method for technological parameters of GaN devices based on a large-signal equivalent circuit model, comprising the following steps:
step 1: establishing a GaN device small-signal equivalent circuit model, and extracting small-signal model parameters;
step 2: establishing a GaN device large-signal equivalent circuit model associated with technological parameters, and extracting large-signal model parameters, the large-signal model parameters comprising non-linear current source model parameters and non-linear capacitance model parameters;
step 3: tuning and optimizing the large-signal model parameters by targeting measured microwave characteristics of the GaN device; and
step 4: extracting technological parameters of GaN devices in multiple batches based on the established large-signal model, and statistically analyzing the technological parameters.

2. The method according to claim 1, wherein the small-signal model parameters comprise parasitic parameters and intrinsic parameters, wherein the parasitic parameters comprise parasitic capacitance, parasitic resistance and parasitic inductance, and the intrinsic parameters comprise intrinsic capacitance, intrinsic resistance, current source and output conductance.

3. The method according to claim 1, wherein extracting small-signal model parameters comprises:
testing scattering parameters of a GaN device in the GaN device small-signal equivalent circuit model under pinch-off condition;
extracting, according to scattering parameters under pinch-off condition, parasitic parameters in the small-signal equivalent circuit model; and
de-embedding all the parasitic parameters, and then calculating small-signal model parameters corresponding to each bias point.

4. The method according to claim 3, wherein, after extracting the small-signal model parameters, the step 1 further comprises:
obtaining simulated scattering parameters by simulation according to the small-signal model parameters;
comparing the simulated scattering parameters with measured scattering parameters to obtain a fitting scattering parameters curve; and
setting a first set of tuning parameters, and repetitively modifying the first set of tuning parameters according to a degree of fitting of the fitting scattering parameter curve until the degree of fitting of the fitting scattering parameter curve conforms to a first set threshold.

5. The method according to claim 1, wherein extracting large-signal model parameters comprises:
testing a GaN device in the GaN device large-signal equivalent circuit model associated with the technological parameters to obtain pulsed I-V test data and static I-V test data;
extracting, according to the pulsed I-V test data, parameters irrelevant to the self-heating effects in an Ids non-linear model;
combining the pulsed I-V test data and the static I-V test data to extract parameters relevant to trapping effects and self-heating effects in the Ids non-linear model;
simulating according to the parameters irrelevant to the self-heating effects in the Ids non-linear model and the parameters relevant to the trapping effects and the self-heating effects in the Ids non-linear model, to obtain pulsed I-V simulation data and static I-V simulation data, respectively;
comparing the pulsed I-V simulation data and static I-V simulation data with the corresponding pulsed I-V test data and static I-V test data, respectively, to obtain I-V fitting curves;
repetitively modifying a second set of tuning parameters according to a degree of fitting of the I-V fitting curves until the degree of fitting of the I-V fitting curves conforms to a second set threshold;
extracting the intrinsic capacitances of the intrinsic parameters, and calculating non-linear capacitance model parameters by fitting values of the intrinsic capacitance at multiple biases;
comparing the calculated non-linear capacitance model parameters with extracted non-linear capacitance model parameters to obtain a contrast ratio; and
setting a third set of tuning parameters, and repetitively modifying the third set of tuning parameters according to the contrast ratio to tune the non-linear capacitance model parameters until the contrast ratio conforms to a third set threshold.

6. The method according to claim 1, wherein tuning and optimizing the large-signal model parameters comprises:
importing the small-signal model parameters and the large-signal model parameters;
setting a fourth set of tuning parameters, and calculating microwave characteristics of a device, wherein the fourth set of tuning parameters comprise device structural and technological parameters such as a thickness of a barrier layer, doping concentration, gate length, gate width and Al component, and microwave characteristics of the large-signal equivalent circuit model comprise at least one of output power, power-added efficiency and gain;
comparing the calculated microwave characteristics of the device and measured microwave characteristics to obtain a fitting microwave characteristic curve; and
repetitively modifying the fourth set of tuning parameters according to a degree of fitting of the fitting microwave characteristic curve until the degree of fitting of the fitting microwave characteristic curve conforms to a fourth set threshold.

7. The method according to claim 5, wherein statistically analyzing the technological parameters comprises:
importing the pulsed I-V test data and static I-V test data of a device to be analyzed, and the small-signal model parameters;
extracting all technological parameters relevant to physical model parameters in the large-signal equivalent circuit model; and
drawing a frequency distribution histogram based on the values of the technological parameters.

8. The method according to claim 7, wherein the physical model parameters comprise device structural and technological parameters during fabrication of the GaN device.
